(19) United States
(12) Patent Application Publication
(10) Pub. No.: US 2008/0094306 A1
(43) Pub. Date: Apr. 24, 2008

(54) Wireless Network Card Antenna Position Structure

(75) Inventor: Gary Hsu, Linkou Township (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BANDRICH INC., Sindian City (TW)

(21) Appl. No.: 11/867,224

(22) Filed: Oct. 4, 2007

(30) Foreign Application Priority Data
Oct. 23, 2006 (TW) 95218704

(51) Int. Cl. H01Q 3/02

(52) U.S. Cl. 343/882

(57) ABSTRACT

A wireless network card antenna position structure is disposed between an antenna and a wireless network card body to adjust and fix a rotational angle between the antenna and the wireless network card body. The wireless network card antenna position structure includes a sunk position piece and a salient position piece. The sunk position piece includes several sunk points and the salient position piece includes at least a salient point. The salient point would couple with at least one of the sunk points to fix the rotational angle of the antenna when the rotational angle of the antenna is adjusted.

### RELATED APPLICATIONS

This application claims priority to Taiwan Application Serial Number 95218704, filed Oct. 23, 2006, which is herein incorporated by reference.

### BACKGROUND

1. Field of Invention

The present invention relates to a wireless network card. More particularly, the present invention relates to a wireless network card antenna position structure.

2. Description of Related Art

The development of the Internet and the popularization of personal computers enable data from different places to be communicated. However, most of the current Internet infrastructure is connected with wires made of different materials, such as optical fibers. Thus, using wireless network cards eliminates the aforementioned problems, and creates a convenient communications environment.

An antenna is an important device in the wireless network card. An antenna rotational angle of the wireless network card can be adjusted with different places and different times to receive better signals. The conventional method for positioning the antenna at a fixed rotational angle is by using the frictional force between the plastic material of the antenna and the wireless network card body. However, attrition of the plastic material may reduce the frictional force between the antenna and the wireless network card body and the antenna cannot be positioned at stable angle.

For the forgoing reasons, there is a need for stably positioning the antenna of the wireless network card.

### SUMMARY

The embodiment of the invention provides a wireless network card antenna position structure for positioning an antenna at a fixed rotational angle with respect to a wireless network card body. The wireless network card antenna position structure includes a sunk position piece and a salient position piece. The sunk position piece with a plurality of sunk points is fixed on a surface between the antenna and the wireless network card body. The salient position piece with at least one salient point is fixed on another surface between the antenna and the wireless network card body. The rotational angle is fixed by coupling at least one salient point and at least one of the sunk points when the rotational angle is adjusted.

The embodiment of the invention also provides a wireless network card. The wireless network card includes an antenna, a wireless network card body, a sunk position piece, an extended portion extended from the sunk position piece, and a salient position piece. The sunk position piece with a plurality of sunk points may be fixed on the antenna. The sunk points may be disposed surrounding the extended portion. The wireless network card body includes an antenna opening disposed facing the antenna. The extended portion may be inserted into the antenna opening. The salient position piece has a plurality of salient points and the salient points are disposed around the antenna opening. The rotational angle between the antenna and the wireless network card body is fixed by coupling the salient points and the sunk points when the rotational angle is adjusted.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an explosion drawing of an embodiment of a wireless network card of the invention;

FIG. 2 is a schematic drawing of an embodiment of the wireless network card antenna position structure of the invention; and

FIG. 3 is an explosion drawing of another embodiment of the wireless network card of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

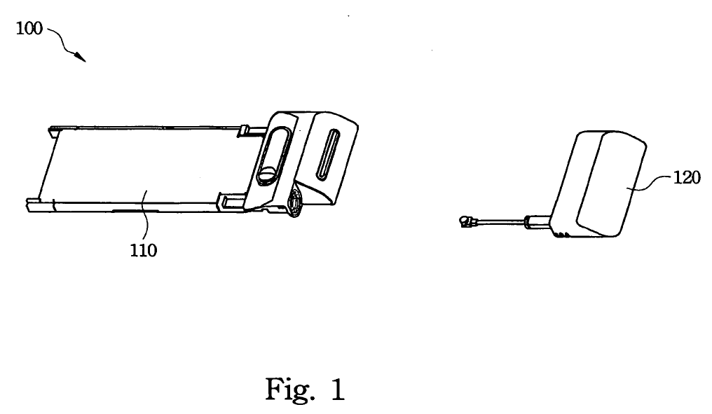

Refer to FIG. 1. FIG. 1 illustrates an explosion drawing of an embodiment of a wireless network card of the invention. The wireless network card 100 includes a wireless network card body 110 and an antenna 120. A rotational angle between the wireless network card body 110 and the antenna 120 needs to be adjusted to fit different locations to receive better signals. Thus, there is a need for a wireless network card antenna position structure to position the antenna 120 and fix the rotational angle between the antenna 120 and the wireless network card body 110 when the rotational angle is adjusted.

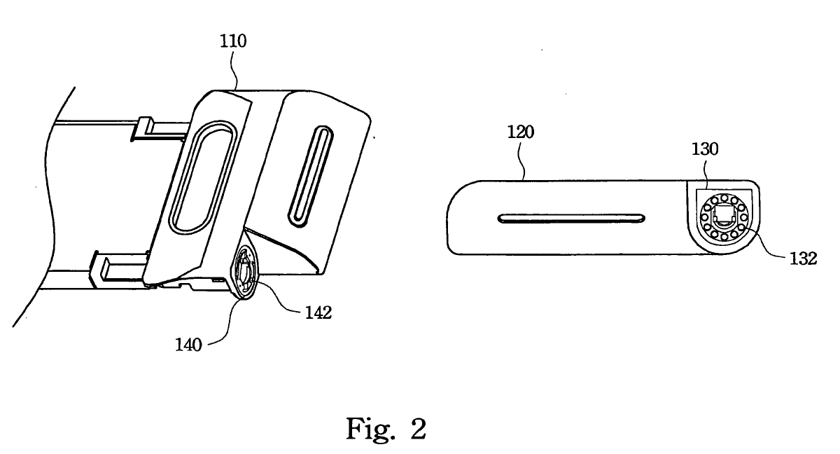

Refer to FIG. 1 and FIG. 2 simultaneously. FIG. 2 is a schematic drawing of an embodiment of the wireless network card antenna position structure of the invention. The wireless network card antenna position structure for securing the antenna 120 at the rotational angle with respect to the wireless network card body 110 includes a sunk position piece 130 and a salient position piece 140. The sunk position piece 130 and the salient position piece 140 are disposed between the antenna 120 and the wireless network card body 110. The sunk position piece 130 is fixed on a surface between the antenna 120 and the wireless network card body 110. The salient position piece 140 is fixed on another surface between the antenna 120 and the wireless network card body 110. In this embodiment, the sunk position piece 130 is fixed on the antenna 120, and the salient position piece 140 is fixed on the wireless network card body 110. In another embodiment, the sunk position piece 130 may be fixed on the wireless network card body 110, and the salient position piece 140 may be fixed on the antenna 120. The sunk position piece 130 includes a plurality of sunk points 132, and the salient position piece 140 includes at least one salient point 142. The salient point 142 may couple with at least one of the sunk points 132 to fix the rotational angle when the rotational angle between the antenna 120 and the wireless network card body 110 is adjusted. The material of the sunk position piece 130 and the salient position piece 140 may be a metal, which is stronger and more resistant to abrasions than plastic. Thus, the wireless network card antenna position structure life may be increased.

The sunk position piece 130 in the embodiment may be a copper pillar fixed in the antenna 120. The sunk points 132 may be disposed circularly on a surface face the wireless network card body 110 of the sunk position piece 130. An angle between the adjacent sunk points 132 is about 30 degrees.

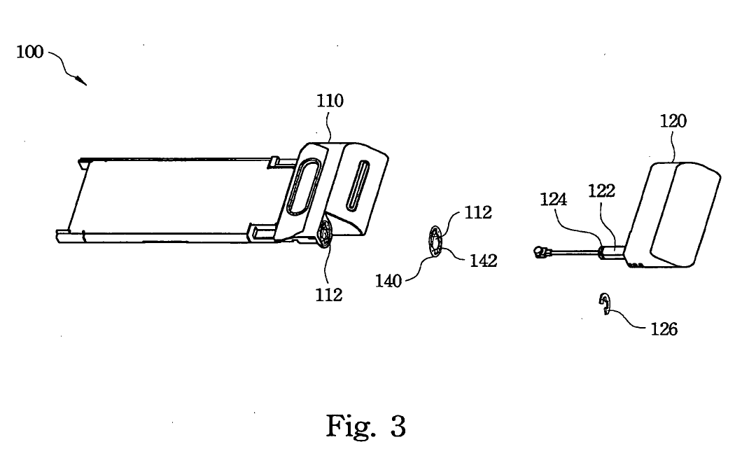

Refer to FIG. 3. FIG. 3 illustrates an explosion drawing of another embodiment of the wireless network card of the invention. There are two of the salient points 142 on the salient position piece 140. The salient points 142 are disposed on two opposite sides of the salient position piece 140 for better balance. The material of the salient position piece 140 may be a beryllium-copper alloy. The salient position piece 140 may have a surface treatment, such as electroplating, for increasing smoothness of the salient points 142.

Refer to FIG. 2 and FIG. 3 simultaneously. The antenna 120 includes an extended portion 122. The extended portion 122 is extended from the copper pillar of the sunk position piece 130. The sunk points 132 may surround the extended portion 122. The wireless network card body 110 has an antenna opening 112 facing the antenna 120. The extended portion 122 of the antenna 120 may be inserted into the antenna opening 112. The material of the extended portion 122 may be a copper. The frictional force generated from the extended portion 122 in contact with a cylinder wall of the antenna opening 112 may stably retain the extended portion 122 in the antenna opening 112.

The salient position piece 140 may also include the antenna opening 112, and the salient points 142 are disposed around the antenna opening 112. The extended portion 122 of the antenna 120 may have a flange 124. The flange 124 is disposed on a section of the extended portion 122 in the wireless network card body 110 and the flange 124 is in contact with the antenna opening 112. The extended portion 122 may further include a retaining ring 126 disposed in the flange 124. The retaining ring 126 may be in contact with the cylinder wall of the antenna opening 112 to prevent the extended portion 122 departing from the antenna opening 112 of the wireless network card body 110. The retaining ring 126 may be an E-shaped retaining ring or a C-shaped retaining ring.

The wireless network card antenna position structure may fix the rotational angle between the antenna and the wireless network card body by coupling the salient points and the sunk points when the rotational angle is adjusted.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wireless network card antenna position structure for securing an antenna at a rotational angle with respect to a wireless network card body comprising:
a sunk position piece with a plurality of sunk points fixed on a surface between the antenna and the wireless network card body; and
a salient position piece with at least one salient point fixed on another surface between the antenna and the wireless network card body, wherein the rotational angle is fixed by coupling the salient point and at least one of the sunk points when the rotational angle is adjusted.

2. The wireless network card antenna position structure of claim 1, wherein a material of the sunk position piece and the salient position piece is a metal.

3. The wireless network card antenna position structure of claim 2, wherein the material of the sunk position piece is a copper.

4. The wireless network card antenna position structure of claim 2, wherein the material of the salient position piece is a beryllium-copper alloy.

5. The wireless network card antenna position structure of claim 1, wherein there are two of the salient points, and the salient points are disposed on two opposite sides of the salient position piece.

6. The wireless network card antenna position structure of claim 1, wherein the sunk points are disposed circularly on the sunk position piece.

7. The wireless network card antenna position structure of claim 6, wherein an angle between the adjacent sunk points is about 30 degrees.

8. The wireless network card antenna position structure of claim 1, wherein the sunk position piece is disposed on the antenna, the salient position piece is disposed on the wireless network card body, wherein the rotational angle between the antenna and the wireless network card body is fixed by coupling the salient position piece and the sunk position piece.

9. The wireless network card antenna position structure of claim 1, wherein the sunk position piece is disposed on the wireless network card body, the salient position piece is disposed on the antenna, wherein the rotational angle between the antenna and the wireless network card body is fixed by coupling the salient position piece and the sunk position piece.

10. A wireless network card comprising:
an antenna;
a sunk position piece fixed on the antenna comprising a plurality of sunk points;
an extended portion extended from the sunk position piece, wherein the sunk points are disposed surrounding the extended portion;
a wireless network card body having an antenna opening disposed facing the antenna, the extended portion inserted in the antenna opening; and
a salient position piece fixed on the wireless network card body having the antenna opening, wherein the salient position piece comprises a plurality of salient points and the salient points are disposed around the antenna opening,
whereby a rotational angle between the antenna and the wireless network card body is fixed by coupling the salient points and the sunk points when the rotational angle is adjusted.

11. The wireless network card of claim 10, wherein a material of the sunk position piece and the salient position piece is a metal.

12. The wireless network card of claim 11, wherein the material of the sunk position piece is a copper.

13. The wireless network card of claim 11, wherein the material of the salient position piece is a beryllium-copper alloy.

14. The wireless network card of claim 10, wherein there are two of the salient points, and the salient points are disposed on two opposite sides of the salient position piece.

15. The wireless network card of claim 10, wherein the sunk points are disposed circularly on the sunk position piece.

16. The wireless network card of claim 10, wherein an angle between the adjacent sunk points is about 30 degrees.

17. The wireless network card of claim 10, wherein the extended portion comprises a flange, the extended portion is inserted into the wireless network card body, the flange is disposed on a section of the extended portion in the wireless network card body and the flange is in contact with the antenna opening.

18. The wireless network card of claim 10, wherein the extended portion comprises a retaining ring disposed in the flange to prevent the extended portion departing from the wireless network card body.

19. The wireless network card of claim 18, wherein the retaining ring is an E-shaped retaining ring.
